(19) United States
(12) Patent Application Publication
(10) Pub. No.: US 2019/0255658 A1
(43) Pub. Date: Aug. 22, 2019

(54) PROCESSING METHOD, PROCESSING SYSTEM, AND NON-TRANSITORY COMPUTER-READABLE MEDIUM STORING A PROCESSING PROGRAM

(71) Applicant: DGSHAPE Corporation, Hamamatsu-shi (JP)

(72) Inventors: Makoto YOSHIDA, Hamamatsu-shi (JP); Toshio MAEDA, Hamamatsu-shi (JP); Jun UEDA, Hamamatsu-shi (JP)

(21) Appl. No.: 16/278,751

(22) Filed: Feb. 19, 2019

(30) Foreign Application Priority Data
Feb. 21, 2018 (JP) 2018-028536

(51) Int. Cl. B23K 26/38; B23K 26/0622

(52) U.S. Cl. CPC B23K 26/38; B23K 26/0624

(57) ABSTRACT

A processing method includes irradiating a processed portion of a light-transmittable material with laser light, and removing an unnecessary portion to form an object. When there are layered processed portions in an emission direction of the laser light, the layered processed portions are irradiated with the laser light in order from the processed portion farthest from a surface of the material which the laser light enters.

### CROSS REFERENCE TO RELATED APPLICATIONS

This application claims the benefit of priority to Japanese Patent Application No. 2018-028536 filed on Feb. 21, 2018. The entire contents of this application are hereby incorporated herein by reference.

### BACKGROUND OF THE INVENTION

### 1. Field of the Invention

The present invention relates to a processing method, a processing system, and a non-transitory computer-readable medium storing a processing program.

### 2. Description of the Related Art

The cutting process is a method for forming an object by applying a cutting tool on a surface of a material and cutting off unnecessary portions (e.g., see Japanese Patent Application Publication No. H10-244439).

For example, as illustrated in FIG. 9A, the cutting process is performed by cutting off processed portions of a fixed material M while moving a cutting tool T from the top along a Z axis so as to follow a previously set processing route.

In this case, when the cutting process is performed from the top of the material M, the cutting tool T cannot be applied on a processed portion located below an object X and a processed portion corresponding to a space portion of the object X (shaded portions in FIG. 9B). For this reason, the material has to be moved or rotated to cut off these processed portions. Thus, the conventional cutting process has a problem of involving complicated processing works, and requiring considerable processing time.

When the cutting process is performed on a hard material, detailed setting of the processing route and low moving speed of the cutting tool are required for preventing breakage of the cutting tool. That is, more processing time is required to cut the hard material.

### SUMMARY OF THE INVENTION

There is an effort to achieve a process similar to the cutting process by using laser light. In this case, the heating process using an infrared laser causes heat effects on not only the processed portions but also the vicinity thereof. Thus, it is difficult to use this process for processing an object requiring high accuracy such as a dental prosthesis.

For this reason, a non-heating process using a short-pulse laser may be applied for the object requiring high accuracy.

In the non-heating process, however, the processed portion irradiated with the laser light is modified (the composition and structure of the material are changed by the laser light energy). Thus, when the non-heating process is performed from the top of the material M like the cutting process illustrated in FIG. 9A, the laser light does not reach the part (shaded portion in FIG. 10) below a modified processed portion P, or unexpected refraction or reflection of the laser light occurs because of a surface roughened by the modification. This makes it difficult to irradiate a preset processed portion with the laser light, and thus the desired object may not be formed.

Preferred embodiments of the present invention provide techniques that enable formation of an object without being affected by modification of a material due to laser light irradiation.

A processing method according to a preferred embodiment of the present invention includes irradiating a processed portion of a light-transmittable material with laser light, and removing an unnecessary portion to form an object in which when there are layered processed portions in an emission direction of the laser light, the layered processed portions being irradiated with the laser light in order from the processed portion farthest from a surface of the material which the laser light enters.

Other features of various preferred embodiments of the present invention will be apparent from the descriptions in this specification.

According to preferred embodiments of the present invention, it is possible to form an object without being affected by modification of a material due to laser light irradiation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram that schematically illustrates a material and an object according to a preferred embodiment of the present invention.

FIG. 2 is a schematic diagram that illustrates a configuration of a processing system according to a preferred embodiment of the present invention.

FIG. 3 is a flowchart that illustrates an operation of a processing system according to a preferred embodiment of the present invention.

FIG. 4A is a diagram that schematically illustrates a material and an object according to a preferred embodiment of the present invention.

FIG. 4B is a diagram that schematically illustrates a material according to a preferred embodiment of the present invention.

FIG. 4C is a diagram that schematically illustrates a material according to a preferred embodiment of the present invention.

FIG. 4D is a diagram that schematically illustrates an object according to a preferred embodiment of the present invention.

FIG. 5 is a diagram that schematically illustrates a material and an object according to a first modification of a preferred embodiment of the present invention.

FIG. 6A is a diagram that schematically illustrates the material and the object according to the first modification of a preferred embodiment of the present invention.

FIG. 6B is a diagram that schematically illustrates the material and the object according to the first modification of a preferred embodiment of the present invention.

FIG. 6C is a diagram that schematically illustrates the material and the object according to the first modification of a preferred embodiment of the present invention.

FIG. 7 is a diagram that schematically illustrates a material according to a second modification of a preferred embodiment of the present invention.

FIG. 8 is a diagram that schematically illustrates the material according to the second modification of a preferred embodiment of the present invention.

FIG. 9A is a diagram for describing a conventional cutting process.

FIG. 9B is a diagram for describing the conventional cutting process.

FIG. 10 is a diagram for describing an effect of modification due to a non-heating process.

### DETAILED DESCRIPTION OF THE PREFERRED EMBODIMENTS

Processing methods according to preferred embodiments include irradiating a processed portion of a material with laser light and removing an unnecessary portion to form an object. Use of the laser light enables non-contact processing.

A laser light-transmittable material (light-transmittable material) is preferably used as the material according to a present preferred embodiment, for example. A zirconia material may be used as the light-transmittable material, for example. The zirconia material may be a compound material such as a zirconia-mixed glass ceramic or may be a single zirconia with a certain transmissibility. The light transmissibility of the material may not have to be 100% as long as it is a value that allows the laser light to reach a predetermined position (processed portion).

The processed portion is a portion on a surface of the material or in the material irradiated with the laser light. The processed portion is specified as multiple line segments (straight or curved), a surface (two-dimensional region having predetermined area), or a solid (three-dimensional region having predetermined volume). A portion of the material (unnecessary portion) is removed by irradiating the processed portion with the laser light. The processed portion irradiated with the laser light is modified (composition and structure of the material are changed by the laser light energy).

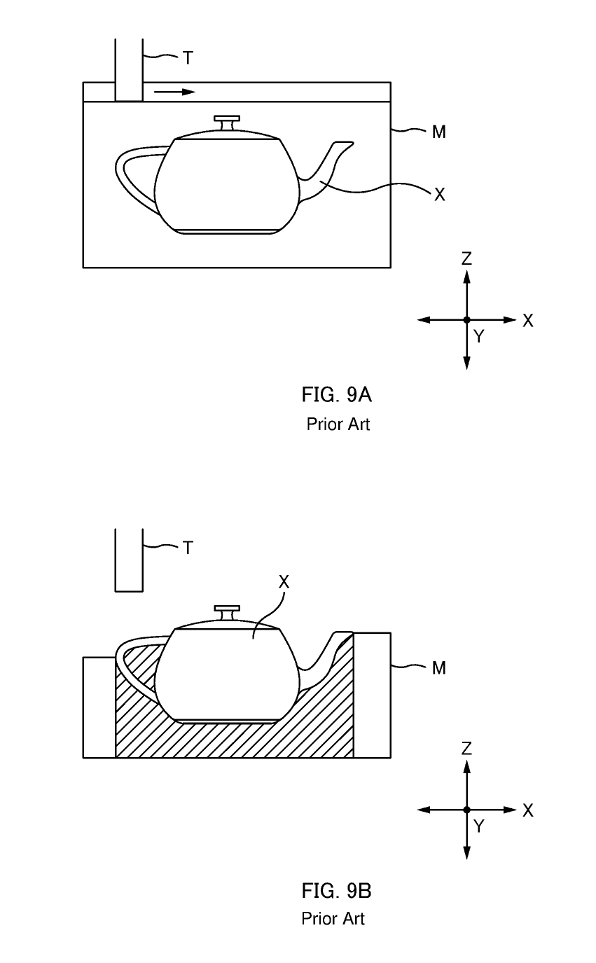

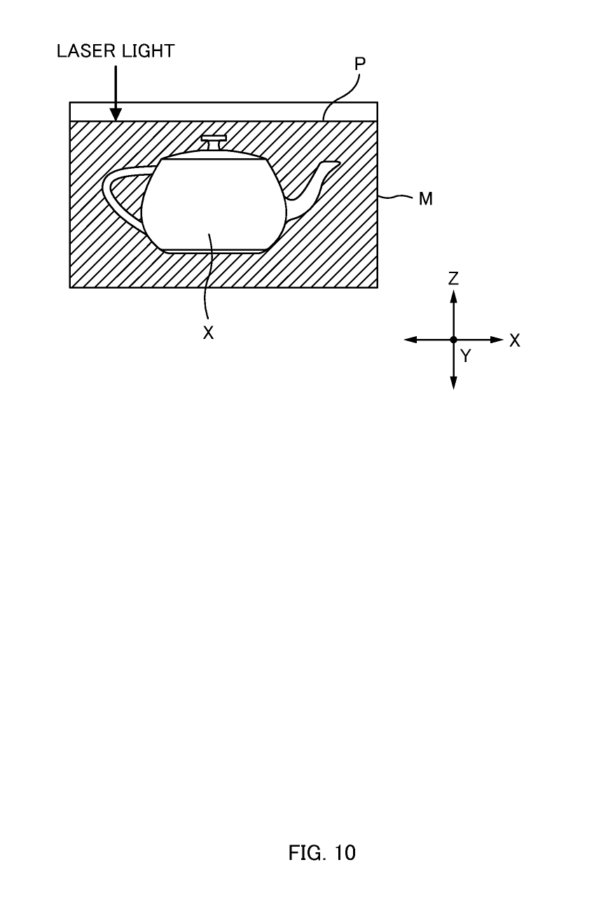

Light of a short-pulse laser is used as the laser light. Particularly, it is preferable to use light of an ultrashort pulse laser to achieve direct laser light irradiation of the processed portion in the material. The ultrashort pulse laser is a laser that emits laser light with a pulse width of several picoseconds to several femtoseconds. Short time irradiation of the processed portion in the material using the laser light of the ultrashort pulse laser enables an ablation process (non-heating process). In the ablation process, since a portion melted by the laser light is immediately evaporated, dispersed, and removed, heat damage of the processed portion is less than the general laser process (heating process). For example, the ablation process enables the direct laser light irradiation of even a processed portion that is hardly processed by the cutting process (e.g., shaded portion in FIG. 9B), and this allows the processing to be solely performed on the processed portion. The ablation process is especially effective at processing a small size object such as a dental prosthesis, for example.

The object is something obtained by processing the material. The unnecessary portion is a portion other than the object in the material (a portion to be removed by the laser light irradiation of the processed portion). For example, in a case where the dental prosthesis is obtained by processing the zirconia material, the prosthesis corresponds to the “object,” and the other portion corresponds to the “unnecessary portion.”

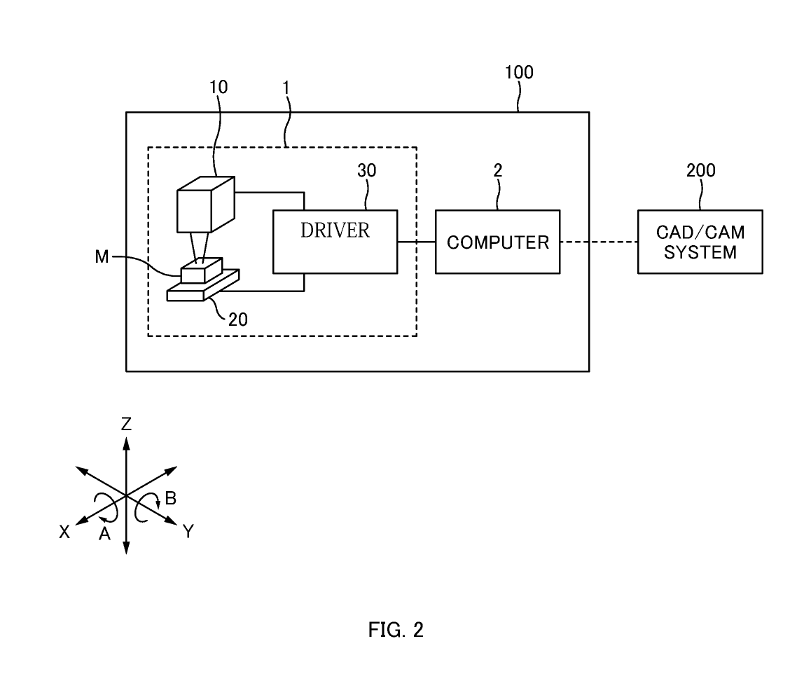

The laser light irradiation of the material is performed based on (later-described) pre-created processing data. More specifically, in the processing method according to this preferred embodiment, when there are layered processed portions in an emission direction of the laser light, the layered processed portions are irradiated with the laser light in order from the processed portion farthest from the surface of the material which the laser light enters. The processing method according to this preferred embodiment is preferably performed by a processing system 100 illustrated in FIG. 2. The processing system 100 processes the material by executing a processing program created by a CAD/CAM system 200. Hereinafter, “processing data,” “processing system,” and “processing by the processing system (processing method)” are described in detail.

The processing data is data used by the processing system 100 to form the object by processing the material. The processing data is created by the CAD/CAM system 200 based on three-dimensional data of the object and three-dimensional data of the material. For example, in the case of processing the dental prosthesis, the processing data is created using three-dimensional data obtained by scanning the inside of a mouth with a CCD camera or an X-ray CT. The three-dimensional data of the object is STL data, solid data used by a three-dimensional CAD, or data such as 3MF or AMR used by a 3D printer.

The processing data according to this preferred embodiment at least includes processed portion data, order data, and processing route data. Multiple pieces of the data are created depending on the number of the processed portions.

A single piece of the processed portion data includes multiple pieces of point data, for example. The multiple pieces of point data are set at predetermined intervals according to the size of the material or the shape of the object. Each of the point data has a three-dimensional (XYZ) coordinate value and vector information.

The coordinate value is used to determine a focal position of the laser light (i.e., the coordinate value corresponds to the position on the surface of the material or in the material irradiated with the laser light). The vector information is used to determine the emission direction of the laser light. In this preferred embodiment, the vector information used in processing of a material is common to all the processed portion data. That is, the laser light emitted based on the processed portion data in this preferred embodiment is emitted from the same direction on all the multiple processed portions. When the laser light enters into the material, an effect of reflection occurs on the surface of the material. Thus, when setting the vector information, it is more preferable to set the vector information such that the laser light enters perpendicularly to the surface of the material. The processed portion data may not be the multiple pieces of the point data as long as it is data that is able to remove the unnecessary portion of the material. For example, the processed portion data may be two-dimensional or three-dimensional region data that specifies an area (position and width) of the material irradiated with the laser light.

The order data is data indicating which processed portion out of the multiple processed portions is to be irradiated with the laser light first (the order of the laser light irradiation). When there are the layered processed portions in the emission direction of the laser light, the order information is set so as to irradiate the layered processed portions with the laser light in order from the processed portion farthest from the surface of the material (in descending order of distance from the surface of the material) which the laser light enters. A distance between the surface of the material and the processed portion is determined according to the above-described direction of the laser light entry. When the single piece of the processed portion data includes the multiple pieces of the point data, the order data may include data indicating which point data indicates the coordinate value from which the laser light is emitted.

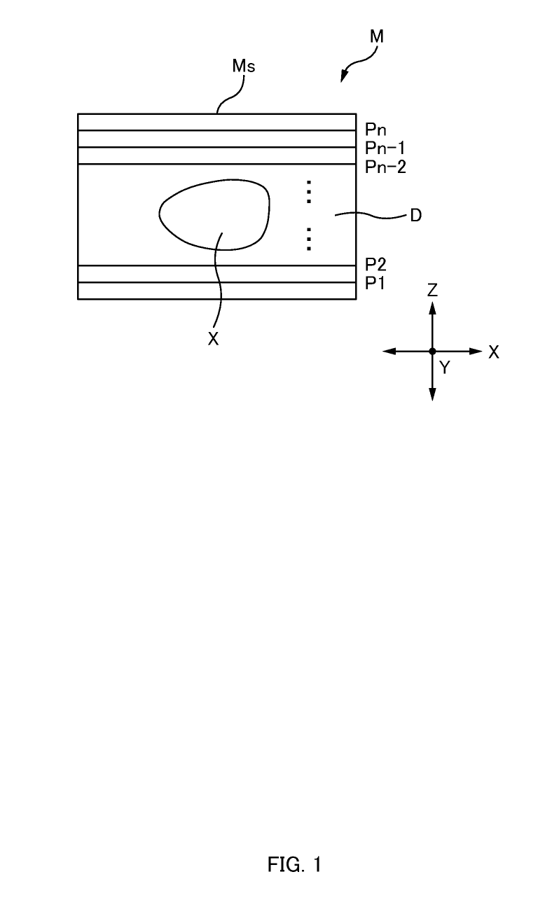

For example, FIG. 1 is a diagram that illustrates a material M and an object X obtained by removing an unnecessary portion D of the material M. X, Y, and Z axes illustrated in FIG. 1 are three axes orthogonal to each other (the same applies hereafter). In this example, in order to obtain the object X, processed portions P1 to Pn specified as line segments have to be irradiated with the laser light to remove the unnecessary portion D.

In this case, for the processed portion data, a three-dimensional coordinate value indicating the position of each of the processed portions P1 to Pn (n is natural number) and the emission direction of the laser light (common to all processed portion data) are set. In the example of FIG. 1, the emission direction of the laser light is set such that the laser light is emitted downward from above along the Z axis. In this case, the processed portions P1 to Pn are layered in the emission direction of the laser light. Thus, in the order data, the processed portion P1, which is the farthest from a surface Ms of the material M which the laser light enters, is set as the first portion (first), and the processed portion Pn, which is the closest to the surface Ms of the material, is the last part (n-th). That is, in the example of FIG. 1, the order of processing is set such that the processed portions are processed from the bottom to the top along the Z axis.

Even when there is a not layered processed portion in the laser light irradiation direction, the order data is also applied to the unlayered processed portion. Note that there is no constraint on the order of the laser light irradiation (order of processing) of the unlayered processed portion. For example, the laser light irradiation of the unlayered processed portion may be performed before the laser light irradiation of the layered processed portions, or it may be performed after the laser light irradiation of all the layered processed portions is completed. Or, the laser light irradiation of the unlayered processed portion may be performed in the middle of the processing of the layered processed portions.

The processing route data is data used to set a route of the laser light irradiation of the processed portions. For example, in the example of FIG. 1, a route in the processing route data of each of the processed portions P1 to Pn is set such that the material M is irradiated with the laser light from the left end to the right end along the X axis.

In addition, the processing data may include data (coordinate values) indicating a shape of the surface of the object and data used to perform finishing (polishing) after removing the unnecessary portion. Also, the processing data may include information on output of the laser light (spot diameter, irradiation time, intensity, and the like of the laser light for irradiation of each point).

The CAD-CAM system 200 outputs the created processing data to the processing system 100. The processing system 100 processes the material by irradiating a position corresponding to the processing data with the laser light. A format of the outputted data is not particularly limited as long as it can be used in the processing system 100.

FIG. 2 is a diagram that schematically illustrates the processing system 100. The processing system 100 includes a processing device 1 and a computer 2. Note that the processing system 100 may include only the processing device 1 by implementing functions of the computer 2 using the processing device 1.

The processing device 1 according to this preferred embodiment includes drive shafts respectively corresponding to five axes (X axis, Y axis, Z axis, A rotational axis (rotational axis about X axis), and B rotational axis (rotational axis about Y axis)). The processing device 1 processes the material M by irradiating the processed portions with the laser light based on the processing data. The processing device 1 includes an emitter 10, a holder 20, and a driver 30.

The emitter 10 irradiates the material M with the laser light. The emitter 10 includes an oscillator of the laser light and an optical system such as a lens assembly and a galvano mirror to introduce the laser light from the oscillator to the material. The holder 20 holds the material M. A way of holding the material is not particularly limited. For example, likewise a case of the conventional cutting process, a disc-shaped material may be held by clipping it with a clamp, or a block-shaped material may be held by bonding a metal pin thereon and inserting the pin into the holder 20. The driver 30 includes a drive motor and the like. The driver 30 moves the emitter 10 and the holder 20 relative to each other. Note that, according to the processing method of this preferred embodiment, it is possible to form the object by emitting the laser light from one direction while the material is fixed. That is, there is no need to rotate the emitter 10 and the holder 20 about the A rotational axis and the B rotational axis.

An adjuster to adjust an emission pattern of the laser may be provided. For example, the adjuster may include at least one of a galvano mirror, a Fresnel lens, a diffractive-optical element (DOE), a liquid crystal on silicon-spatial light modulator (LCOS-SLM), and the like. The adjuster is provided, for example, between the oscillator and the lens assembly in the emitter 10.

For example, when the processed portions are the three-dimensional regions, use of the LCOS-SLM as the adjuster allows the processed portions to be irradiated with the laser light all at once. The LCOS-SLM is able to form the laser light from the oscillator in any shape by adjusting the orientation of the liquid crystal. For example, the LCOS-SLM enables emission of laser light in a thin plate shape (three-dimensional-shaped laser light) by forming the beam-shaped laser light in a planar configuration and providing a predetermined thickness. Use of such an LCOS-SLM enables the ablation process to be performed on the entirety of each processed portion with one emission, for example. That is, since the use of the LCOS-SLM allows a wide processed portion to be processed all at once, it is possible to reduce the processing time.

The computer 2 controls operations of the emitter 10 and the driver 30. More specifically, the computer 2 adjusts the relative positional relation between the emitter 10 and the holder 20 (material M) by controlling the driver 30 so that the processed portion corresponding to the processing data is able to be irradiated with the laser light on the surface of the material or in the material. The computer 2 controls the emitter 10 to adjust the focal position of the laser light, the spot diameter and intensity of the emitted laser light, and the like, and to irradiate the material M with the laser light for a predetermined time. The spot diameter, intensity, irradiation time, and the like affect output of the emitted laser light (energy). These values may be included in advance in the processing data as described above, or may be set in the processing device 1. The type and characteristic of the material as a target of the processing may be taken into consideration when determining the values. The computer 2 is an example of a “controller.”

The processing system 100 according to this preferred embodiment can perform not only processing of the object but also the finishing thereof by adjusting output of the laser light emitted from the emitter 10. That is, since the processing device 1 can perform the whole processing from processing of the material M to creating of the object, there are no risks of increase of the processing time and decrease of the processing accuracy due to attaching and detaching of the material M.

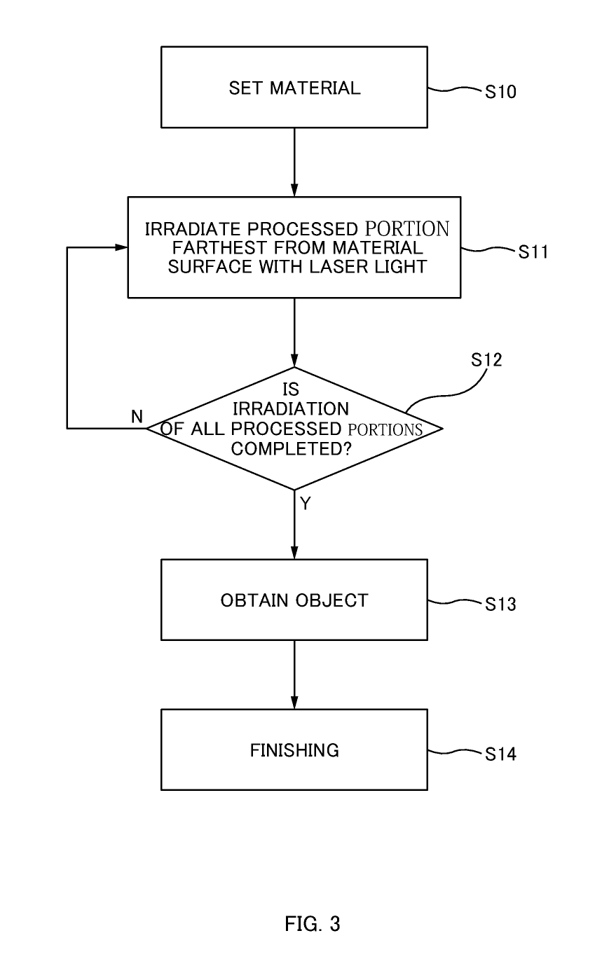

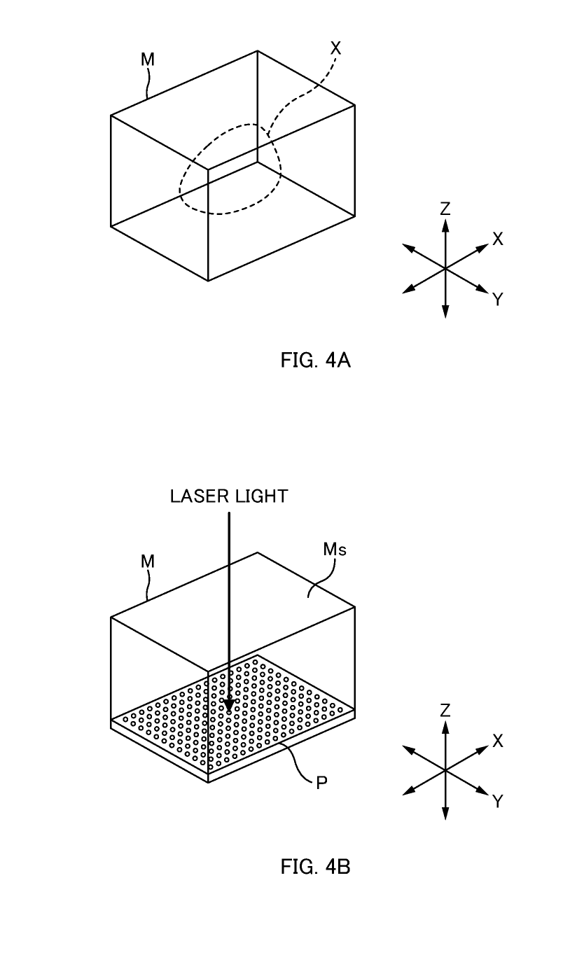

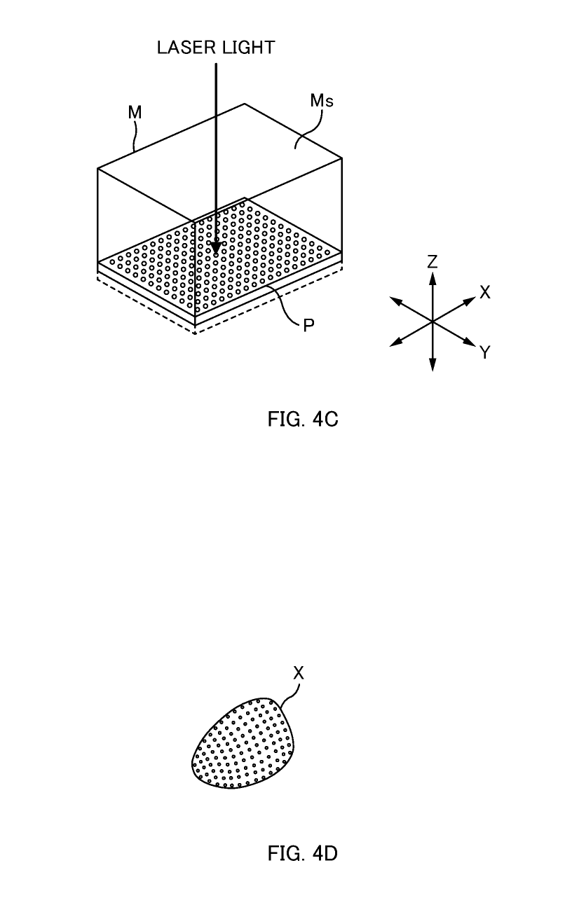

Next, a specific example of a processing method according to a preferred embodiment of the present invention is described with reference to FIGS. 3 to 4D. The processing method is executed preferably by the processing system 100. The processing method is installed as a dedicated processing program in advance in the processing system 100. In this example, the object X is obtained by processing the material M. FIG. 3 is a flowchart that illustrates an operation of the processing system 100. FIGS. 4A to 4D are diagrams that schematically illustrate the material M to be processed by the processing method or the object X according to this preferred embodiment. The processing data of the object X is created in advance by the CAD/CAM system 200. In this example, multiple processed portions are layered.

The material M used to create the object X is selected and set on the holder 20 of the processing device 1 (set material; step 10). FIG. 4A illustrates the material M fixed in the processing device 1. The material M according to this preferred embodiment is block-shaped, for example. In FIG. 4A, the object X to be formed is indicated by a broken line.

The computer 2 allows the processing device 1 to execute processing of the material M based on the processing data of the object X. In this example, the laser light is emitted downward from above along the Z axis.

The computer 2 allows the processing device 1 to irradiate the laser light to the position (processed portion), which is indicated by the processed portion data included in the processing data. In this step, based on the order data, the computer 2 allows the processing device 1 to irradiate the laser light first to the processed portion P, which is the farthest from the surface Ms of the material which the laser light enters (irradiates the processed portion farthest from surface of material with laser light first; step 11).

The computer 2 allows the processing device 1 to make adjustment to match the coordinate value of the point data included in the processed portion data and the focal position of the laser light. More specifically, the computer 2 allows the processing device 1 to adjust the relative positions of the emitter 10 and the holder 20 and to adjust the orientations and angles of the lens unit and galvano mirror included in the emitter 10. The adjustment of the focal position is performed taking into consideration the refractive index of the material M. Once the coordinate value of the point data and the focal position of the laser light coincide with each other, the computer 2 controls the emitter 10 and allows the laser light to be emitted from above along the Z axis for the predetermined time based on the vector information included in the point data.

When the processed portion P is a two-dimensional plane as illustrated in FIG. 4B, the computer 2 allows the processing device 1 to sequentially irradiate the coordinate values, which are indicated by the multiple pieces of the point data forming the processed portion P, with the laser light based on the processing route data (see FIG. 4B; portions irradiated with laser light are indicated by circles). The portions (processed portions) irradiated with the laser light are hollows each corresponding to the spot diameter of the laser light. A portion located below the processed portion P (unnecessary portion) is dropped off because of its weight or an external force. The laser light irradiation may be performed such that the positioning and the irradiation are repeated as described above, or, taking into consideration the processing efficiency, in a case where the focal position does not change, processing of a position corresponding to adjacent point data may be sequentially performed while keeping the laser light irradiation.

Once the irradiation of the processed portion P farthest from the surface of the material with the laser light is completed, the computer 2 allows the processing device 1 to irradiate the laser light to a processed portion (which is the second farthest from the surface of the material), based on the order data.

Based on the order data, the computer 2 allows the processing device 1 to irradiate the processed portions with the laser light in the order from the processed portion farthest from the surface of the material (in this example, order from a processed portion located below the material M) to remove the unnecessary portion. Such laser light irradiation makes it possible to remove the unnecessary portion without being affected by the modification due to the laser light irradiation even when the processed portions are layered in the emission direction of the laser light. For example, when the processed portion P illustrated in FIG. 4B is irradiated with the laser light, the unnecessary portion located below the processed portion P is removed (removed unnecessary portion is indicated by broken line in FIG. 4C). Thus, the portion located below the processed portion P does not have to be irradiated with the laser light again. In addition, the processed portion P illustrated in FIG. 4C is located above the processed portion P irradiated with the laser light earlier (see FIG. 4B). Thus, the laser light for the irradiation of the processed portion P in FIG. 4C is not affected by the modification of the processed portion P in FIG. 4B.

When the laser light irradiation of all the processed portions is completed (Y in step 12), the unnecessary portion of the material M is removed and the object X is obtained (obtain object; step 13).

When the ablation process is performed by the laser light irradiation based on the processing data, the shape of the surface of the object X obtained by removing the unnecessary portion may be almost similar to the three-dimensional data as a basis of the processing data. On the other hand, depending on the shape of the object, intensity of the points, state of the laser irradiation, and the like, the unnecessary portion may partially remain on the surface of the object X, and this may roughen the surface of the object X. Thus, it is more preferable to perform the finishing in terms of enhancing the processing accuracy of the object.

The computer 2 allows the processing device 1 to perform the finishing by polishing the object X obtained in step 13 with the laser light (finishing; step 14). A way of the finishing (way of polishing) is not particularly limited. For example, when data on the shape of the surface of the object X is included in the processing data, the remaining unnecessary portion is able to be removed by the laser light irradiation based on the data on the shape of the surface of the object X (see FIG. 4D; portions irradiated with laser light are indicated by circles).

An example in which the finishing is performed by polishing with the laser light is described; however, the finishing may be performed by conventional mechanical polishing. Also, dyeing and grazing may be performed as the finishing by providing a dedicated configuration in the processing system 100.

An example in which the laser light is emitted to the material M from above along the Z axis (laser light is emitted downward) is described above; however, it is not limited thereto. The laser light may be emitted to the material M from below along the Z axis (laser light is emitted upward), or may be emitted from the side along the X or Y axis orthogonal to the Z axis (laser light is emitted in a crosswise direction). Otherwise, when the surface of the material M is inclined, or depending on the shape of the object, the laser light may be emitted in an oblique direction. In any case, when there are layered processed portions in the emission direction of the laser light, the unnecessary portion is able to be removed without being affected by the material modification by irradiating the layered processed portions with the laser light in the order from the processed portion farthest from the surface of the material which the laser light enters (order from a processed portion having a long distance from the surface of the material), and the object is thus formed.

As described above, the processing method according to this preferred embodiment is a processing method that preferably includes irradiating the processed portion of the light-transmittable material M with the laser light and removing the unnecessary portion to form the object, and when there are the layered processed portions in the emission direction of the laser light, the layered processed portions are irradiated with the laser light in the order from the processed portion farthest from the surface of the material which the laser light enters.

As described above, since the layered processed portions are irradiated with the laser light in the order from the processed portion farthest from the surface of the material which the laser light enters, the emitted laser light is not affected by the modification. That is, there hardly occurs a problem in that the laser light cannot pass through the modified processed portion, or a problem in that the laser light refracts or reflects in the modified processed portion and accurate laser light irradiation of another processed portion is failed. As described above, according to the processing method of this preferred embodiment, it is possible to form the object without being affected by the modification of the material due to the laser light irradiation.

In the processing method according to this preferred embodiment, it is preferable to emit the laser light from above the material M while the material M is fixed. If the laser light is emitted from above, the unnecessary portion is sequentially removed from the lower side of the material (e.g., see FIGS. 4B and 4C). Since the removed unnecessary portion is dropped off with the own weight, there is no need to remove the unnecessary portion generated in the processing.

In the processing method according to this preferred embodiment, it is preferable that the laser light enters the surface of the material perpendicularly, for example. If the laser light enters perpendicularly, displacement of the position of the light focus point due to refraction of the laser light is able to be avoided.

In the processing method according to this preferred embodiment, it is preferable that the laser light is the light of the ultrashort pulse laser. Use of the light of the ultrashort pulse laser enables direct processing (non-heating process) on the processed portions in the material.

In addition, the processing system 100 according to this preferred embodiment is a processing system that irradiates the processed portion of the light-transmittable material with the laser light and removes the unnecessary portion to form the object, which includes the emitter 10, the holder 20, the driver 30, and the computer 2 (controller). The emitter 10 emits the laser light. The holder 20 holds the material M. The driver 30 moves the emitter 10 and the holder 20 relative to each other. When there are the layered processed portions in the emission direction of the laser light, the computer 2 controls the emitter 10 and the driver 30 to irradiate the layered processed portions with the laser light in order from the processed portion farthest from the surface of the material which the laser light enters. Moreover, the processing program according to this preferred embodiment is a program that causes the processing system 100, which irradiates a processed portion of a light-transmittable material with laser light and removes an unnecessary portion to form an object, to execute a process that includes, when there are the layered processed portions in the emission direction of the laser light, irradiating the layered processed portions with the laser light in order from the processed portion farthest from the surface of the material which the laser light enters. According to the processing system 100 and the processing program, it is possible to form the object without being affected by the modification of the material due to the laser light irradiation.

When the object X is obtained by the processing method of the above preferred embodiment, the processing time is shorter than that of the conventional cutting process. Note that further processing time reduction is possible by removing the unnecessary portion more efficiently.

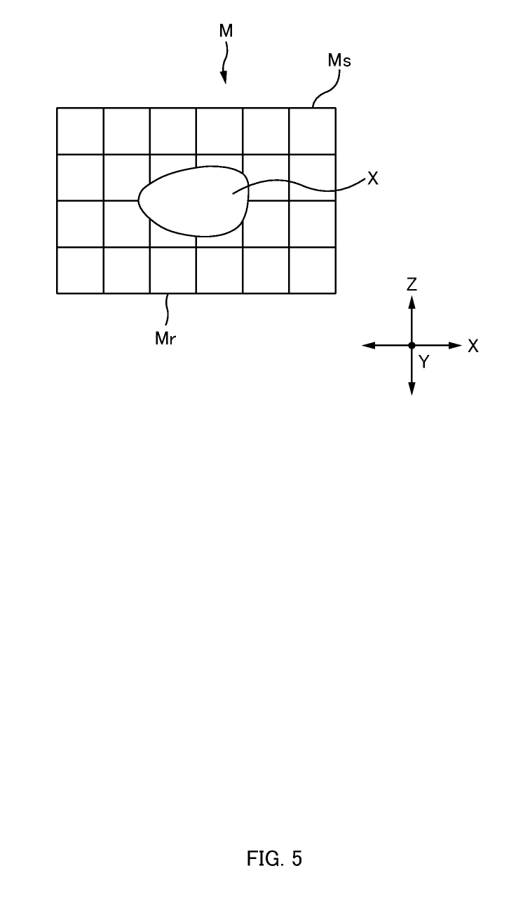

More specifically, the unnecessary portion may be divided into blocks. FIG. 5 illustrates an example in which the unnecessary portion is divided into blocks. In the example of FIG. 5, borders of each block (line segments in longwise and crosswise direction) correspond to the processed portions. The processing system 100 irradiates the processed portions with the laser light so as to remove the unnecessary portion in every divided block. When there are layered processed portions in the emission direction of the laser light, the processing system 100 irradiates the layered processed portions with the laser light in the order from the processed portion farthest from the surface of the material which the laser light enters, in this example as well.

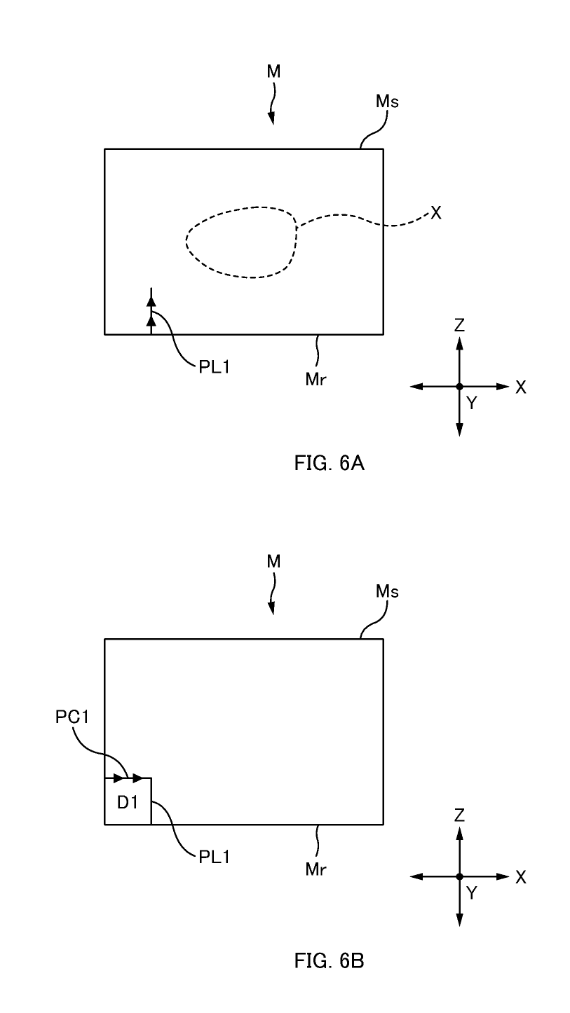

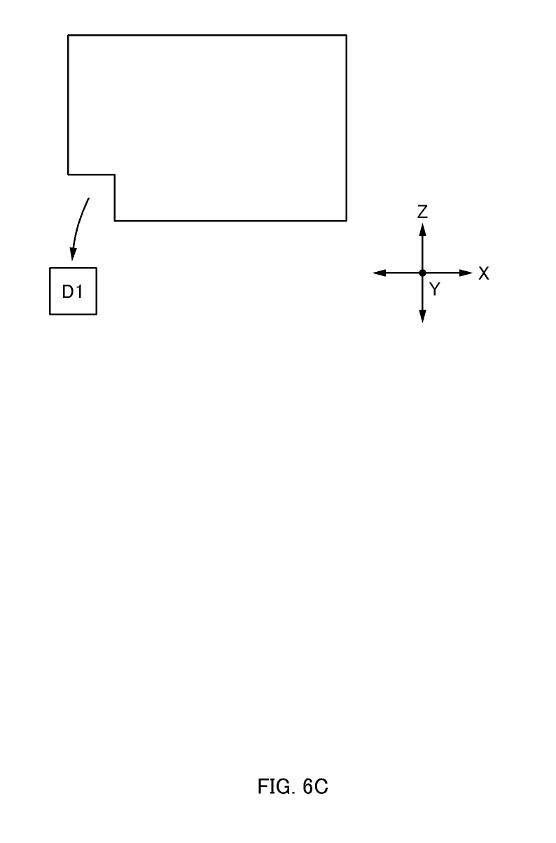

In the example of FIG. 5, the laser light is emitted to the material M from above along the Z axis. In this case, the processed portions in the longwise direction and the processed portions in the crosswise direction are layered in each direction. In this case, the processing system 100 performs processing of the processed portions in the order from the processed portion farthest from the surface Ms of the material which the laser light enters. For example, the processing system 100 processes the processed portion PL1, which is the farthest from the surface of the material which the laser light enters out of the processed portions in the longwise direction (see FIG. 6A). The processed portion PL1 is a processed portion having a length in the Z axis direction. In this case, the computer 2 allows the processing device 1 to process of the processed portion PL1 by sequentially making the laser light irradiation upward from the farthest position from the surface Ms of the material (bottom Mr of material M).

Next, the processing system 100 processes a processed portion PC1, which is the farthest from the surface of the material which the laser light enters out of the processed portions in the crosswise direction (see FIG. 6B). An unnecessary portion D1 is removed by processing the processed portions PL1 and PC1 (see FIG. 6C). In this case, since the unnecessary portion D1 falls off due to its weight and gravity by sequentially performing the processing from the lower side of the material M, there is no need to remove the unnecessary portion generated in the processing.

The unnecessary portion may not fall due to its weight and gravity depending on the type of the material or the state after the laser light irradiation. In this case, the unnecessary portion can be removed by applying an external force to the processed material M. The unnecessary portion can be removed by various ways depending on the type or physicality of the material.

For example, the unnecessary portion can fall off by emitting the laser light with similar output power as the general heating process and applying a heat impact on the material M. In this case, the same emitter 10 is able to be used. Otherwise, the unnecessary portion is able to fall off by providing a configuration dedicated for the removing in the processing system 100.

For example, a configuration to inject a refrigerant gas or dry ice for cooling is provided. The unnecessary portion can fall off due to injecting the refrigerant gas and the like and rapidly cooling the material M. Otherwise, a horn generating ultrasound may be provided to apply ultrasound vibration to the material M locally, or a hammer and the like may be provided to apply a force to the material M directly (using physical interference).

An example in which the blocks are removed one after another is described in this modification; however, it is not limited thereto. For example, the processing system 100 sequentially irradiates all the processed portions in the lengthwise direction (see FIG. 5) with the laser light from the bottom Mr to the surface Ms of the material M along the Z axis. Thereafter, the processing system 100 processes all the processed portions illustrated in FIG. 5 by horizontally moving the laser light, which is emitted along the Z axis, from left to right along the X axis while irradiating the processed portions in the crosswise direction in the order from the processed portion farthest from the surface Ms of the material. The processing system 100 also can remove all the unnecessary portions at once by applying an external force to the processed material M.

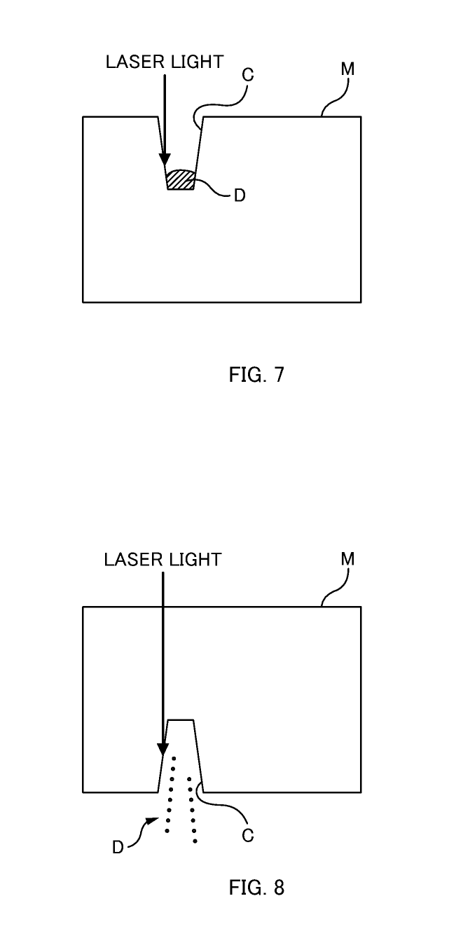

Depending on the material being used, there may be a dent such as a hole or groove on the surface. When such a dent C of the material M is irradiated with the laser light, the removed unnecessary portion D is accumulated in the dent (see FIG. 7).

When the surface of the material includes the dent, it is preferable that the material is fixed such that an opening of the dent faces downward and the laser light is applied from a side of a surface of the material opposite from the surface including the dent (see FIG. 8). As illustrated in FIG. 8, if the opening of the dent C faces downward, the removed unnecessary portion D is not accumulated in the dent C. Thus, there is no need to remove the unnecessary portion accumulated in the dent every time, and the processing works can proceed efficiently.

Even when the material does not include the dent, the dent may be formed on the surface of the object obtained by the processing. In this case, likewise the example of FIG. 7, the unnecessary portion removed by the processing is accumulated in the dent on the object. Thus, in a case of forming the dent on the surface of the object, it is preferable that the material is fixed such that the surface on which the opening of the dent is to be formed faces downward, and the laser light is applied from a side of a surface opposite from the surface on which the dent is to be formed. If the material is fixed in this way such that the opening of the dent faces downward, the unnecessary portion generated in the processing is not accumulated in the dent.

It is also possible to supply a program in the computer using a non-transitory computer-readable medium with an executable program thereon. The non-transitory computer-readable medium is, for example, a magnetic recording medium (e.g., flexible disc, magnetic tape, hard disc drive), CD-ROM (read only memory), and so on.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A processing method, comprising:
irradiating a processed portion of a light-transmittable material with laser light; and
removing an unnecessary portion to form an object; wherein
when there are layered processed portions in an emission direction of the laser light, the layered processed portions are irradiated with the laser light in order from the processed portion farthest from a surface of the light-transmittable material which the laser light enters.

2. The processing method according to claim 1, wherein the laser light is emitted from above the light-transmittable material while the light-transmittable material is fixed.

3. The processing method according to claim 1, wherein the laser light is emitted so as to divide the unnecessary portion into blocks.

4. The processing method according to claim 1, wherein
when a surface of the light-transmittable material includes a dent, the light-transmittable material is fixed such that an opening of the dent faces downward; and
the laser light is applied from a side of a surface of the light-transmittable material opposite from the surface including the dent.

5. The processing method according to claim 1, wherein
in a case of forming a dent on a surface of the object, the light-transmittable material is fixed such that the surface on which an opening of the dent is to be formed faces downward; and
the laser light is applied from a side of a surface opposite from the surface on which the dent is to be formed.

6. The processing method according to claim 1, wherein the laser light enters the surface of the light-transmittable material perpendicularly.

7. The processing method according to claim 1, wherein the laser light is light of an ultrashort pulse laser.

8. A processing system that irradiates a processed portion of a light-transmittable material with laser light and removes an unnecessary portion to form an object, the processing system comprising:
an emitter that emits the laser light;
a holder that holds the light-transmittable material;
a driver that moves the emitter and the holder relative to each other; and
a controller that controls the emitter and the driver when there are layered processed portions in an emission direction of the laser light to irradiate the layered processed portions with the laser light in order from the processed portion farthest from a surface of the light-transmittable material which the laser light enters.

9. A non-transitory computer-readable medium storing a processing program that causes a processing system to execute a process comprising:
irradiating a processed portion of a light-transmittable material with laser light;
removing an unnecessary portion to form an object; and
when there are layered processed portions in an emission direction of the laser light, irradiating the layered processed portions with the laser light in order from the processed portion farthest from a surface of the light-transmittable material which the laser light enters.
